(19) United States
(12) Patent Application Publication
(10) Pub. No.: US 2003/0188434 A1
(43) Pub. Date: Oct. 9, 2003

(54) Tool assembly having changeable saw blades and tools

(76) Inventor: Li Jiun Chiu, Taichung (TW)

Correspondence Address: Li Jiun Chiu, P.O. Box 65-45, Taichung, 403, TW

(21) Appl. No.: 10/117,793

(22) Filed: Apr. 5, 2002

(51) Int. Cl. B26B 1/02

(52) U.S. Cl. 30/144; 30/329

(57) ABSTRACT

A tool assembly includes a handle having a barrel, one ends of one or more tool members or of one or more shanks are engageable into detachably secured to the barrel. A sleeve is engaged onto the shank, an insert and one end of one or more saw blades are engaged into the sleeve, and one or more fasteners may detachably secure the saw blades and the insert and the insert to the shank. The tool members and/or the saw blades may be detachably and changeably secured to the barrel, and the saw blades may be changeably and solidly secured to the handle with the sleeve and the insert.

### BACKGROUND OF THE INVENTION

1. Field of the Invention

The present invention relates to a tool assembly, and more particularly to a tool assembly having changeable saw blades and tool members.

2. Description of the Prior Art

Typical tool assemblies may include various kinds of tool bits or tool members that may be changed with each other for driving different or various kinds of fasteners. However, the saw blades of the saw tools should be solidly secured in place, and may not be changeably secured to the typical tool devices.

The present invention has arisen to mitigate and/or obviate the afore-described disadvantages of the conventional tool assemblies.

### SUMMARY OF THE INVENTION

The primary objective of the present invention is to provide a tool assembly including one or more saw blades and one or more tool members that may be changed with each other.

The other objective of the present invention is to provide a tool assembly including one or more saw blades that may be solidly secured to the tool handle.

In accordance with one aspect of the invention, there is provided a tool assembly comprising a handle including a barrel provided thereon, the barrel including an engaging hole formed therein, and including an aperture formed therein and communicating with the engaging hole thereof, a ball slidably received in the aperture of the barrel and movable into the engaging hole of the barrel, a first tool member including a first end for selectively engaging into the engaging hole of the barrel, and including a second end having an engaging hole formed therein for receiving either tool elements or fasteners, the first end of the first tool member including an annular groove formed therein for selectively receiving the ball and for selectively securing the first tool member to the barrel, a second tool member including a first end for selectively engaging into the engaging hole of the barrel, and including a second end having a shank, the shank including a notch formed therein, the first end of the second tool member including an annular groove formed therein for selectively receiving the ball and for selectively securing the second tool member to the barrel, means for detachably engaging the ball in the annular grooves of the first and the second tool members, a sleeve engaged onto the shank of the second tool member, an insert engaged into the sleeve and engaged in the notch of the shank, a saw blade including a first end engaged into the sleeve and engaged in the notch of the shank, and engaged between the shank and the insert, and means for detachably securing the shank and the insert and the sleeve and the saw blade together. The tool members and/or the saw blades may thus be detachably and changeably secured to the barrel, and the saw blades that may be solidly secured to the tool handle.

The insert includes a depression formed therein, the shank includes a projection extended therefrom and engaged into the depression of the insert for further securing the insert to the shank.

The saw blade includes a finger extended from the first end thereof and having a height smaller than that of the first end of the saw blade for forming a shoulder between the finger and the first end of the saw blade and for receiving the projection of the shank.

The detachably securing means includes a fastener threaded through the sleeve and engaged through the insert and the saw blade and engaged into the shank.

The detachably engaging means includes a ferrule rotatably engaged onto the barrel, the ferrule includes an annular depression formed therein for selectively receiving the ball, and includes a peripheral bulge formed therein for selectively engaging with the ball to force the ball to engage into the annular grooves of either of the first and the second tool members.

The handle includes a first end having a block pivotally secured thereto with a shaft, the block includes an outer peripheral portion having a plurality of teeth formed thereon, the tool assembly further includes a knob slidably received in the handle and selectively engageable with the teeth of the block for securing the handle to the block at any selected angular position.

The handle includes a pair of channel formed therein, the knob includes a pair of pins laterally extended outward therefrom and slidably engaged in the channels of the handle, for allowing the knob to be slightly moved along the channels of the handle.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a tool assembly in accordance with the present invention;

FIG. 2 is a further partial exploded view of the tool assembly;

FIG. 3 is a plan view of the handle, in which a portion of the handle is cut off for showing the inner structure of the handle;

FIG. 4 is a partial cross sectional view illustrating the attachment or the securing of the tool member to the handle of the tool assembly;

FIG. 5 is a partial cross sectional view illustrating the attachment or the securing of the saw blade to the driving shank of the tool assembly; and

FIG. 6 is a plan view illustrating the operation of the saw and the handle of the tool assembly.

### DETAILED DESCRIPTION OF THE PREFERRED EMBODIMENT

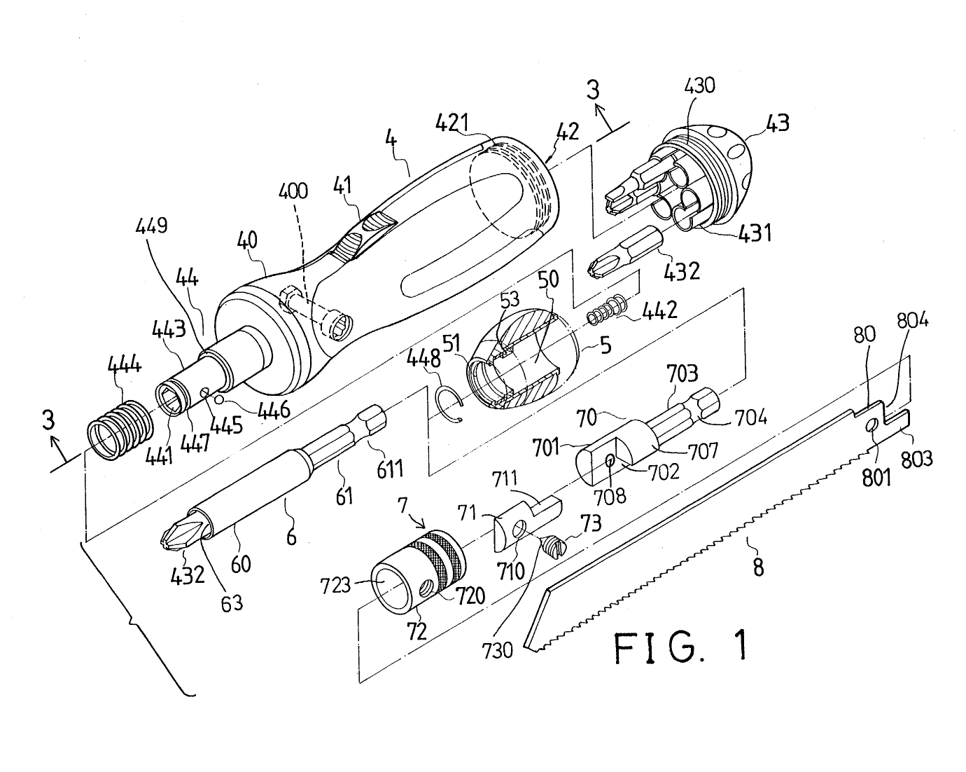

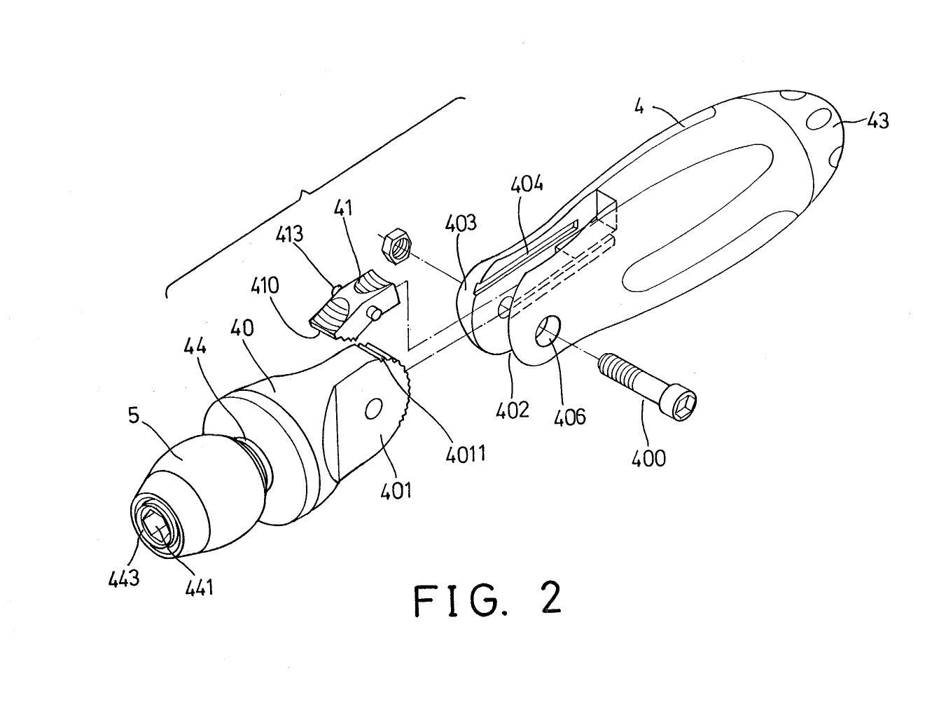

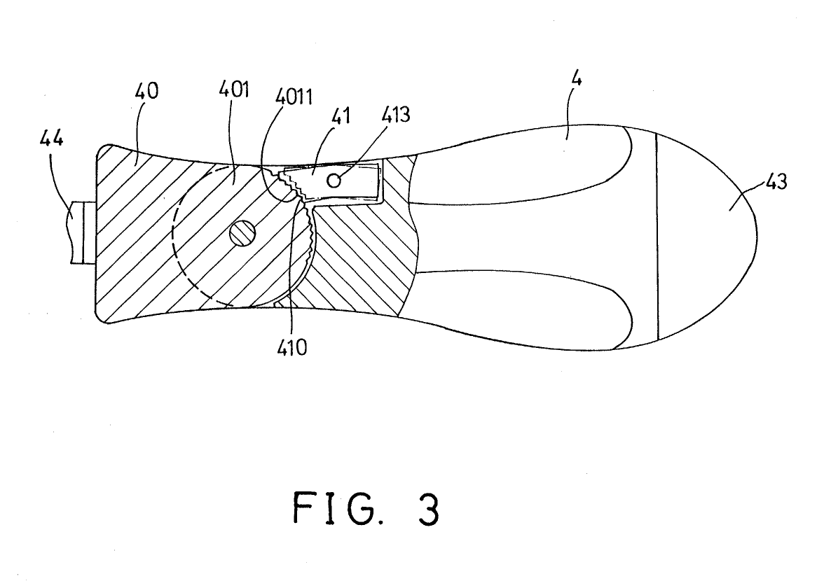

Referring to the drawings, and initially to FIGS. 1-3 and 6, a tool assembly in accordance with the present invention comprises a handle 4 including a slot 402 formed in one end thereof, such as formed in the front end thereof for forming or defining a pair of opposite or spaced arms 403. The handle 4 includes a pair of channels 404 formed in the inner surfaces of the arms 403 respectively, and includes an orifice 406 formed therein and intersecting or communicating with the slot 402 of the handle 4, for receiving a fastener or a shaft 400.

The handle 4 includes a hollow interior or a chamber 42 formed in the other end thereof, such as formed in the rear end thereof, and includes an inner thread 421 formed in the rear end thereof. A cover 43 includes an outer thread 430 formed thereon for threading with the inner thread 421 of the handle 4 and for detachably securing the cover 43 to the handle 4. The cover 43 includes one or more hubs 431 extended or provided therein for receiving one or more tool members or elements or bits 432 or the like. The tool bits 432 may be engaged and received in the chamber 42 of the handle 4 by securing the cover 43 to the rear end of the handle 4.

The handle 4 includes a block 40 having a number of teeth 4011 formed in one end thereof, such as formed in or around the rear end 401 thereof. The shaft 400 is engaged through the block 40 or the rear end 401 of the block 40 for rotatably securing the block 40 to the handle 4. A knob 41 is slidably engaged in the slot 402 of the handle 4, and includes a pair of pins 413 laterally extended outward therefrom and slidably engaged in the channels 404 of the handle 4, for allowing the knob 41 to be slightly moved in or along the slot 402 of the handle 4.

The knob 41 includes one or more teeth 410 formed or provided on the front end thereof for engaging with the teeth 4011 of the block 40, and for securing the block 40 relative to the handle 4 at the required angular positions. For example, the teeth 410 of the knob 41 may be engaged with and secured to the teeth 4011 of the block 40 with such as a force-fitted engagement, for securing the block 40 to the handle 4 at the required angular positions. Or, alternatively, a spring (not shown) may be provided and engaged with the knob 41 for biasing the knob 41 to engage its teeth 410 with the teeth 4011 of the block 40.

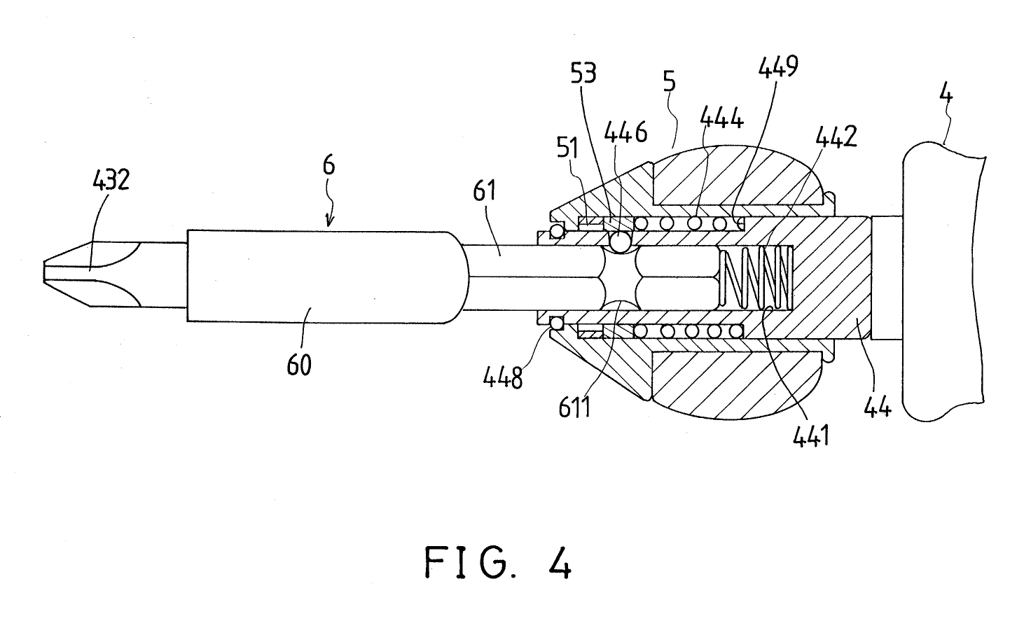

The block 40 or the handle 4 includes an extension 44 extended forward therefrom, and a barrel 443 extended forward from the extension 44 and having an outer diameter smaller than that of the extension 44 for forming a peripheral shoulder 449 between the barrel 443 and the extension 44. The barrel 443 includes an engaging hole, such as a hexagonal engaging hole 441 formed therein for receiving the end portions 61, 703 of the shanks 60, 70 of the tool members 6, 7 or for receiving the tool bits 432; and includes an aperture 445 formed therein and communicating with the engaging hole 441 thereof for receiving a ball 446, which may engage with the annular grooves 611, 704 of the tool members 6, 7 (FIG. 4), for detachably securing the tool members 6, 7 to the barrel 443. A spring 442 (FIG. 4) may be engaged in the engaging hole 441 of the barrel 443 and/or of the extension 44 for engaging with the tool members 6, 7.

A ferrule 5 includes a bore 50 formed therein for rotatably receiving the extension 44 and the barrel 443, and for rotatably securing the ferrule 5 onto the extension 44 and the barrel 443. A retaining ring 448 is engaged in an annular recess 447 of the barrel 443 for engaging with the ferrule 5 and for preventing the ferrule 5 from being disengaged from the extension 44 and the barrel 443. The ferrule 5 includes a peripheral depression 51 and a peripheral bulge 53 formed or extended or provided in the front portion of the ferrule 5. A spring 444 is engaged onto the barrel 443 and engaged with the peripheral shoulder 449 of the extension 44 and engaged with the peripheral bulge 53 of the ferrule 5 for biasing the peripheral bulge 53 to engage with the ball 446 and to force the ball 446 to engage with and to secure the tool members 6, 7 to the barrel 443.

In operation, as shown in FIG. 4, the end portions 61, 703 of the shanks 60, 70 of the tool members 6, 7 may be engaged into the engaging hole 441 of the barrel 443 and/or of the extension 44 and may be engaged with the spring 442. The spring 444 may bias the peripheral bulge 53 of the ferrule 5 to engage with the ball 446 and to force the ball 446 to engage with the annular grooves 611, 704 of the tool members 6, 7, in order to detachably secure the tool members 6, 7 to the barrel 443. The spring 442 may bias the tool member 6 outward of the barrel 443 when the ball 446 is disengaged from the annular groove 611 of the tool member 6. The tool member 6 includes a shank 60 having an engaging hole 63 formed therein for receiving the tool bit 432 and for allowing the tool bit 432 to be rotated and driven by the tool member 6 and the handle 4.

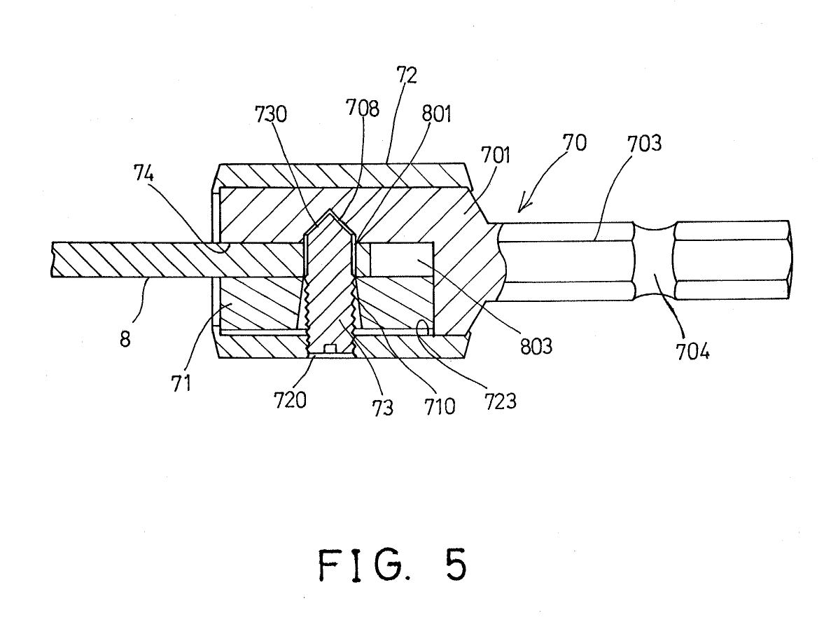

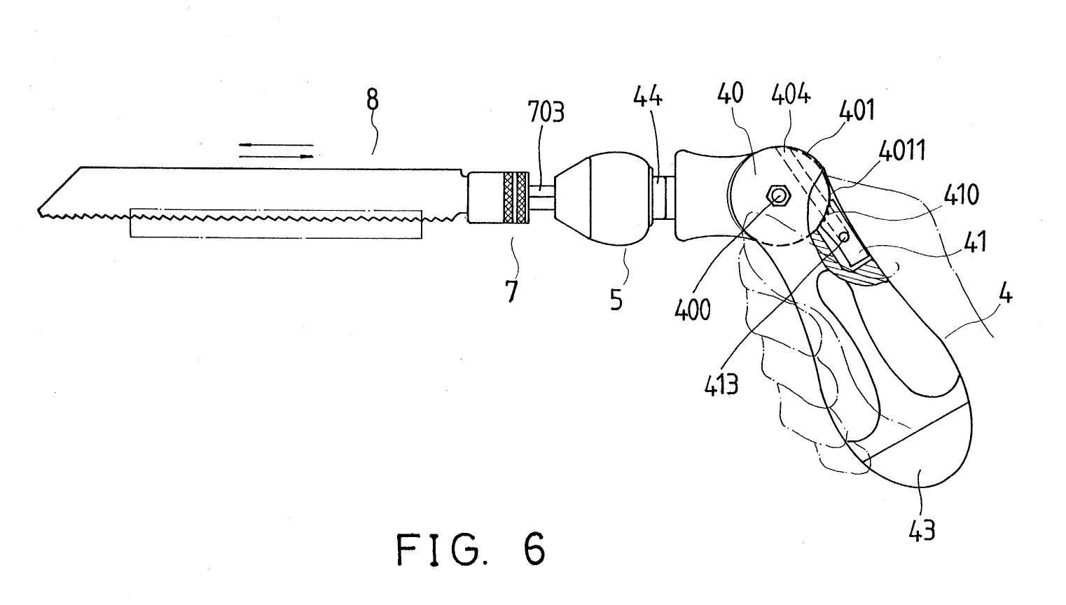

Referring next to FIGS. 5, 6 and again to FIG. 1, the tool member 7 includes a shank 70 having a semi-cylindrical body 701, and having a relative semi-cylindrical notch 702 formed therein, and having a projection 707 extended from the body 701 and extended inward of the notch 702 of the shank 70, and having a cavity 708 formed in the body 701 and communicating with the notch 702 thereof. A presser or an insert 71 is engaged into the notch 702 of the shank 70, and includes a hole 710 for receiving a fastener 73, and includes a cut-off depression 711 formed therein for receiving the projection 707 of the shank 70 and for allowing the insert 71 to be moved and disengaged from the notch 702 of the shank 70 in only one direction; i.e., the insert 71 is only allowed to be moved away from the shank 70 in a direction away from the projection 707 and the end portion 703 thereof.

A sleeve 72 includes a bore 723 formed therein for receiving the shank 70 and the insert 71, and includes a hole or a screw hole 720 formed therein for receiving the fastener 73. A saw blade 8 includes one end 80 engageable into a gap 74 that is formed between the shank 70 and the insert 71 (FIG. 5), and includes a hole 801, and a finger 803 extended from the one end 80 thereof. The finger 803 includes a height smaller than that of the one end 80 of the saw blade 8, for forming a cut-off cavity 804 or a shoulder 804 therein, and for receiving the projection 707 of the shank 70, and for allowing the saw blade 8 to be solidly secured in the sleeve 72 and between the insert 71 and the shank 70.

The fastener 73 may be threaded with the screw hole 720 of the sleeve 72, and engaged through the hole 710 of the insert 71, and through the hole 801 of the saw blade 8, and has a con-shaped tip 730 (FIG. 5) for engaging into the cavity 708 of the shank 70, and for securing the saw blade 8 and the sleeve 72 and the insert 71 to the body 701 of the shank 70. The saw blade 8 may thus be solidly secured to the tool member 70, and the tool member 70 may then be selectively and detachably secured to the barrel 443.

In operation, as shown in FIG. 4, when the ferrule 5 is moved toward the handle 4 against the spring 444, the ball 446 may be received in the depression 51 of the ferrule 5 and may thus be disengaged from the annular grooves 611, 704 of the tool members 6, 7, such that the end portions 61, 703 of the shanks 60, 70 of the tool members 6, 7 may be engaged into the engaging hole 441 of the barrel 443. As shown in FIG. 5, the saw blade 8 may be secured to the shank 70 with the sleeve 72 and the insert 71, and the shank 70 may then be detachably secured to the barrel 443 with the ferrule 50. When the ferrule 5 is released, the spring 444 may bias the peripheral bulge 53 of the ferrule 5 to engage with the ball 446 and to force the ball 446 to engage with the annular grooves 611, 704 of the tool members 6, 7, in order to detachably secure the tool members 6, 7 to the barrel 443.

Accordingly, the tool assembly in accordance with the present invention includes one or more saw blades and one or more tool members that may be changed with each other and the saw blades may be solidly secured to the tool handle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool assembly comprising:
a handle including a barrel provided thereon, said barrel including an engaging hole formed therein, and including an aperture formed therein and communicating with said engaging hole thereof,
a ball slidably received in said aperture of said barrel and movable into said engaging hole of said barrel,
a first tool member including a first end for selectively engaging into said engaging hole of said barrel, and including a second end having an engaging hole formed therein for receiving either tool elements or fasteners, said first end of said first tool member including an annular groove formed therein for selectively receiving said ball and for selectively securing said first tool member to said barrel,
a second tool member including a first end for selectively engaging into said engaging hole of said barrel, and including a second end having a shank, said shank including a notch formed therein, said first end of said second tool member including an annular groove formed therein for selectively receiving said ball and for selectively securing said second tool member to said barrel,
means for detachably engaging said ball in said annular grooves of said first and said second tool members,
a sleeve engaged onto said shank of said second tool member,
an insert engaged into said sleeve and engaged in said notch of said shank,
a saw blade including a first end engaged into said sleeve and engaged in said notch of said shank, and engaged between said shank and said insert, and
means for detachably securing said shank and said insert and said sleeve and said saw blade together.

2. The tool assembly according to claim 1, wherein said insert includes a depression formed therein, said shank includes a projection extended therefrom and engaged into said depression of said insert for further securing said insert to said shank.

3. The tool assembly according to claim 2, wherein said saw blade includes a finger extended from said first end thereof and having a height smaller than that of said first end of said saw blade for forming a shoulder between said finger and said first end of said saw blade and for receiving said projection of said shank.

4. The tool assembly according to claim 1, wherein said detachably securing means includes a fastener threaded through said sleeve and engaged through said insert and said saw blade and engaged into said shank.

5. The tool assembly according to claim 1, wherein said detachably engaging means includes a ferrule rotatably engaged onto said barrel, said ferrule includes an annular depression formed therein for selectively receiving said ball, and includes a peripheral bulge formed therein for selectively engaging with said ball to force said ball to engage into said annular grooves of either of said first and said second tool members.

6. The tool assembly according to claim 1, wherein said handle includes a first end having a block pivotally secured thereto with a shaft, said block includes an outer peripheral portion having a plurality of teeth formed thereon, said tool assembly further includes a knob slidably received in said handle and selectively engageable with said teeth of said block for securing said handle to said block at any selected angular position.

7. The tool assembly according to claim 6, wherein said handle includes a pair of channel formed therein, said knob includes a pair of pins laterally extended outward therefrom and slidably engaged in said channels of said handle, for allowing said knob to be slightly moved along said channels of said handle.
